(19) United States
(12) Patent Application Publication
(10) Pub. No.: US 2026/0017307 A1
(43) Pub. Date: Jan. 15, 2026

(54) SYSTEMS AND METHODS FOR DYNAMICALLY GENERATING COMMUNICATION CHANNELS USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Kaitlyn Jones, Charlotte, NC (US); Lauran A. Hollar, Conover, NC (US); Kelly Renee-Drop Keiter, Waxhaw, NC (US); Jinna Kim, Charlotte, NC (US); Michael R. Young, Davidson, NC (US); Sophie Morgan Danielpour, Charlotte, NC (US); Vinicius Mouffron Ribas Da Costa, Charlotte, NC (US)

(73) Assignee: BANK OF AMERICA CORPORATION, CHARLOTTE, NC (US)

(21) Appl. No.: 18/767,274

(22) Filed: Jul. 9, 2024

(51) Int. Cl. G06F 16/34; G06F 16/335; G06F 16/387

(52) U.S. Cl. CPC G06F 16/345; G06F 16/337; G06F 16/387

(57) ABSTRACT

Systems, computer program products, and methods are described herein for dynamically generating communication channels using advanced computational models for data analysis and automated processing. The present disclosure is configured to receive a set of user personas, wherein the set of user personas is associated with each user of a team, and wherein the team comprises a plurality of users; receive a set of device data, wherein the set of device data comprises user device information associated with a user device associated with each user of the team; receive an event, wherein the event comprises a task to be completed to resolve the event; and determine a designated user to complete the task, wherein the determination is based on the set of user personas, the set of device data, and the event.

### TECHNOLOGICAL FIELD

Example embodiments of the present disclosure relate to dynamically generating communication channels using advanced computational models for data analysis and automated processing.

### BACKGROUND

There are significant challenges associated with determining event resolution techniques. Applicant has identified a number of deficiencies and problems associated with assigning tasks to resolve events. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for dynamically generating communication channels using advanced computational models for data analysis and automated processing.

Embodiments of the present invention address the above needs and/or achieve other advantages by providing apparatuses (e.g., a system, computer program product, and/or other devices) and methods for dynamically generating communication channels using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives a set of user personas, wherein the set of user personas is associated with each user of a team, and wherein the team includes a plurality of users. In some embodiments, the present invention receives a set of device data, wherein the set of device data includes user device information associated with a user device associated with each user of the team. In some embodiments, the present invention receives an event, wherein the event includes a task to be completed to resolve the event. In some embodiments, the present invention determines a designated user to complete the task, wherein the determination is based on the set of user personas, the set of device data, and the event.

In some embodiments, the set of user personas further includes a user disposition, wherein the user disposition is associated with each user of the team, and wherein the disposition includes a user attribute and a user questionnaire. In some embodiments, the user attribute includes an ability of each user of the team to complete the task. In some embodiments, the user questionnaire includes a task preference of each user of the team.

In some embodiments, the set of device data further includes geolocation data, historical usage data, and device performance. In some embodiments, the geolocation data includes a physical location of the user device. In some embodiments, the historical usage data includes uptime of each of the user of the set of users. In some embodiments, the device performance includes functionality data of each user device associated with each user of the team.

In some embodiments, the designated user includes one or more users of the team.

In some embodiments, determining the designated user further includes determining an initial designated user to complete at least a portion of the task, wherein the initial designated user is based on the set of user personas, the set of device data, and the event. In some embodiments, determining the designated user further includes determining an additional designated user to complete at least an additional portion of the task, wherein the additional designated user is based on the set of user personas, the set of device data, and the event.

In some embodiments, the present invention generates a summary report, wherein the summary report includes information associated with the event, the designated user, the task, and completion status of the task. In some embodiments, the present invention generates an action report, wherein the action report includes an additional task necessary to be completed to resolve the event. In some embodiments, the present invention generates an assignment report, wherein the assignment report includes assigning the additional task to the designated user. In some embodiments, the present invention transmits the summary report, the action report, and the assignment report to the designated user.

In some embodiments, transmitting the summary report, the action report, and the assignment report to the designated user further includes transforming the summary report, the action report, and the assignment report into a modality based on a user modality preference.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for dynamically generating communication channels using advanced computational models for data analysis and automated processing, in accordance with an embodiment of the disclosure;

FIG. 2 illustrates a process flow for dynamically generating communication channels using advanced computational models for data analysis and automated processing, in accordance with an embodiment of the disclosure; and

FIG. 3 illustrates an example embodiment of the system described herein, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In the modern world, event resolution procedures of an entity are critical to maintaining infrastructure of the entity that operates in an efficient and expected manner. These procedures may provide the entity with valuable insight into its systems and processes to determine what events arose and how those events were resolved. The events as described herein may include scheduled or unscheduled events. For example, a scheduled event may include routine maintenance, updates, change orders, additional orders, deletion orders, scheduled downtime, or the like. In another example, unscheduled events may include interruption events, malware resolution, unexpected outages or downtime, errors, component degradation, or the like. Typically, a team may be tasked with resolving the event at hand. This team may be spread out across the globe, especially given current technologies allowing for remote working capabilities. For entities with conventional event resolution procedures and team members dispersed in varying geographic locations, this may translate into difficulties due to varying skill levels, personalities, time zones, device capability, language barriers, and the like of the team. In other words, conventional procedures to resolve events may not be equipped to handle the varying landscape and litany of issues associated with efficient and effective mitigation and resolution of the events. Therefore, systems and methods for dynamically generating communication channels using advanced computational models for data analysis and automated processing are introduced.

The present disclosure provides a communication generation system (e.g., the system 130 as described herein) for determining a designated user carry out a task that may resolve an event. Initially, the communication generation system may receive information associated with each user on a team, which may include user persona information from user attributes and user questionnaires. The user persona may be used to determine how well-suited a user is for completing the task(s) associated with an event. Further, the communication generation system may receive device data of the device associated with the users on the team. The device data may include geolocation data, historical usage data, and performance data. The device data may show where the user is located, which time zone the user is in, the capabilities of the user's device, and historical records of prior tasks assigned to the user. An artificial intelligence (AI) model may determine that a certain user (e.g., the designated user) is equipped to complete a task that at least partially resolves the event. If necessary, the AI model may also determine an additional designated user should be assigned an additional task.

Further, the AI model may generate reports associated with the task, the event, and the user's completion of the task and/or event. These reports may be distributed to the team, the user, and the entity. The distribution of the report to the user may vary in modality (e.g., a visual summary, auditory summary, or the like) according to the user's preference. In addition, the reports may include summary reports, action reports, and assignment reports to detail the completion status of the tasks and events, and any outstanding tasks that may need to yet be completed. The AI model may continuously learn from the procedures and reports to determine the most efficient and effective way of completing future tasks and events.

What is more, the present disclosure provides a technical solution to a technical problem. As described herein, the technical problem includes determining assignment of tasks associated with event resolution, wherein the assignment includes efficiently determining a user to complete the task. The technical solution presented herein allows for dynamically determining a designated user on a team to complete a task associated with an event by accounting for user personas and device data of each of the users on the team. In particular, the communication generation system (e.g., the system 130) is an improvement over existing solutions to the issues associated with task assignment for teams spread across different geographic regions that need to work together to resolve the event, (i) with fewer steps to achieve the solution, thus reducing the amount of computing resources, such as processing resources, storage resources, network resources, and/or the like, that are being used (e.g., by determining a designated user among the users of a team, wherein the designated user is selected based on the user persona, device data, and the event), (ii) providing a more accurate solution to problem, thus reducing the number of resources required to remedy any errors made due to a less accurate solution (e.g., accounting for geographic variations of users, language barriers, skill levels, and the like), (iii) removing manual input and waste from the implementation of the solution, thus improving speed and efficiency of the process and conserving computing resources (e.g., automatically and dynamically designating a user to complete the task via the AI model), (iv) determining an optimal amount of resources that need to be used to implement the solution, thus reducing network traffic and load on existing computing resources (e.g., efficiently designating a user based on resources available to the user to complete the task). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the communication generation system as described herein is a solution to the problem of determining resources (e.g., personnel resources, computing resources, networking resources, etc.) to resolve events. Further, the communication generation system may be characterized as identifying a specific improvement in computer capabilities and/or network functionalities in response to the communication generation system's integration to existing devices, software, applications, and/or the like. In this way, the communication generation system improves the capability of a system to resolve events via assignment of tasks to users by analyzing performance conditions of the user and capabilities of the user's device. Further, the communication generation system improves the functionality of networks in response to reducing the resources consumed by the system (e.g., personnel resources, network resources, computing resources, memory resources, and/or the like).

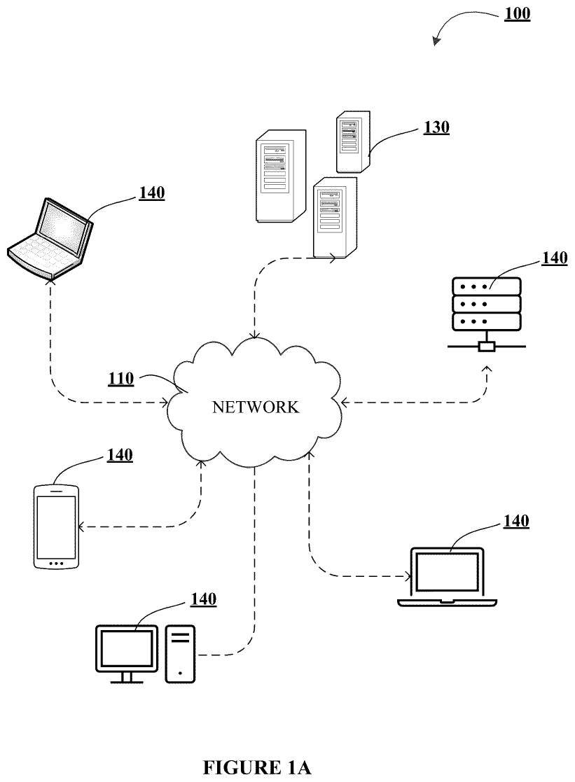

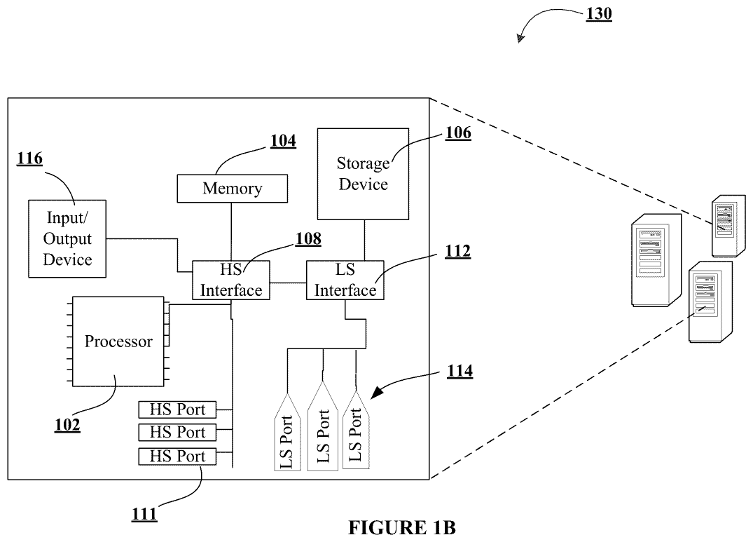

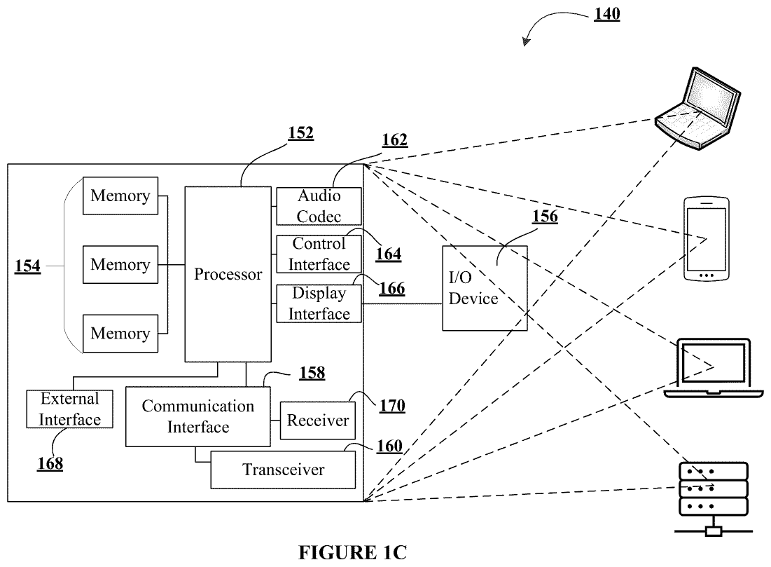

FIGS. 1A-1C illustrate technical components of an exemplary distributed computing environment 100 for dynamically generating communication channels using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

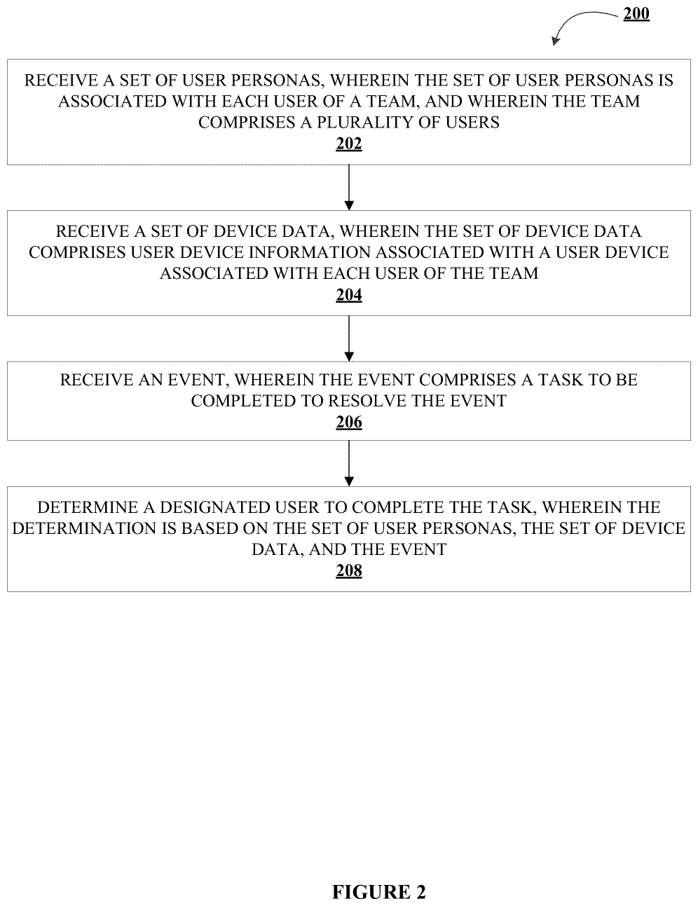

FIG. 2 illustrates a process flow for dynamically generating communication channels using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a communication generation system (e.g., similar to one or more of the systems described herein with respect to FIGS. 1A-1C) may perform one or more of the steps of process flow 200. For example, a communication generation system (e.g., the system 130 described herein with respect to FIGS. 1A-1C) may perform the steps of process flow 200.

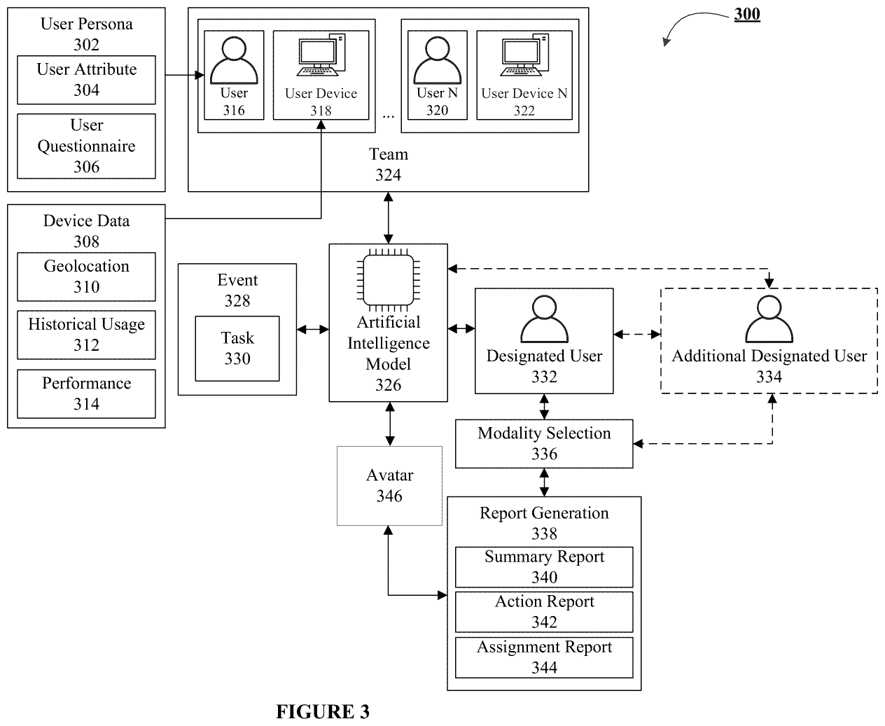

As shown in block 202, the process flow 200 of this embodiment includes receiving a set of user personas, wherein the set of user personas is associated with each user of a team, and wherein the team includes a plurality of users. For example, as shown in FIG. 3, a team 324 may include a plurality of users, which may include a first user (e.g., a user 316), a second user (not shown), an Nth user (e.g., user N 320), and the like. The team may be associated with an entity and may include a formal structure, an internal department, an informal structure, a collaboration of individuals, or the like. In some embodiments, the team may be wholly associated with the entity (e.g., employees of the entity). In some embodiments, the team may be at least partially associated with the entity and may be at least partially made up of third parties, contractors, experts, or the like. Additionally, or alternatively, the team may be dispersed across the world, across one or more countries, across regions, across states, across cities, or the like. In this way, the team may include users who are in different geographic locations, time zones, and the like. Further, users on the team may be associated with different cultures from their counterpart users. In this way, the users on the team may have differing priorities and availabilities due to their geographic locations and/or cultures.

In some embodiments, the set of user personas further includes a user disposition, wherein the user disposition is associated with each user of the team. The user disposition may include a user attribute and a user questionnaire. For example, as shown in FIG. 3, the user persona 302 may include a user attribute 304 and a user questionnaire 306. The user attribute may include the ability of each user associated with the team to complete the task. The users' ability to complete tasks may be determined through historical performance reports associated with the users on the team. This may include experience levels, length of time performing tasks related to the task at hand, strengths of the user, weaknesses of the user, and the like. In this way, the user attribute may relate to how well the user performs under working conditions. Additionally, or alternatively, the communication generation system may determine a user is most productive at certain times of the day. Further, the system may analyze the user's productivity to determine a peak productivity time for each user.

The user questionnaire may include a task preference of each user associated with the team. The user questionnaire may be a formal documentation of the user's preferences, whereby the user fills out a form to indicate the user's preferred working conditions, which may include task assignments. In some embodiments, the user questionnaire may include informal preferences, whereby the user indicates the user's preferences in an informal setting, or the user's preferences are determined through inputs to the system. In this way, the preferences may be determined through efficiency metrics associated with the user's performance of tasks. For example, if a task is expected to take a user a certain amount of time given the user's experience, but the user takes longer than expected to complete the task, the system (e.g., the system 130) may determine the task is outside of the user's preference and indicate as such on the user questionnaire.

In some embodiments, the user personas may also be used to build a user avatar. For example, as shown in FIG. 3, the AI model 326 may generate the avatar 346 based on the user persona 302 of the user 316. The avatar may be a representation of the user in the system (e.g., system 130 as described herein). The avatar may have traits, dispositions, personas, attributes, and the like that resemble those of the user based on the user's persona. In some embodiments, the avatar may be a graphical representation of the user, an audio representation of the user, or may represent the user in a textual form (e.g., through comments, notes, explanations, electronic communications, or the like). Further, users of the system may interact with the avatars of themselves or of other users. In this way, the avatars may deliver information to a user similar to how the avatar's user may deliver the information.

As shown in block 204, the process flow 200 of this embodiment includes receiving a set of device data, wherein the set of device data includes user device information associated with a user device associated with each user of the team. In some embodiments, the user device (e.g., end-point device(s) 140 or the like) may include the device used to complete the task assigned to the user. The user device may include mobile devices, personal computing devices, tablets, servers, virtual reality devices, augmented reality devices, extended reality devices, parallel reality devices, or the like. Further, the user device information may relate to the user device. The device data may be used to determine efficiencies of the user as the user performs tasks. For example, as shown in FIG. 3, a user device 318 may be associated with a user 316. The user device 318 may include device data 308, which may include geolocation data 310, historical usage data 312, and performance data 314. Further, the device data may be used to determine user availability and working trends of the user.

The geolocation data may include a physical location of the user device, which may include longitude and latitude, global positioning system coordinates, an address, or the like. The geolocation data may be used to determine where the user device is physically situated, which time zone the user is in, and the like. In some embodiments, the geolocation of the user device may provide the location of the user as well. In this way, the user device may be linked to the user through login information to provide the geolocation of the user.

The historical usage data may include uptime of each user of the set of users (e.g., the team). The uptime may include the time the user spends resolving a task, event, project, or the like. The uptime of the user may indicate that the user has preferred allotments of time that the user is available. For example, the uptime may show that the user is typically available late at night or early in the morning. Further, the system may analyze the user's uptime to determine the user's peak productivity time.

The device performance may include functionality data of each user device associated with each user of the team. The functionality of the user device may indicate that the user device has the capability and/or resources to complete certain tasks. The system may determine and update the user device's capabilities by analyzing the user device to determine its performance capabilities, memory capabilities, which programs or applications it has, and the like. For example, the user device may have certain programs or applications installed that allow the user to perform certain operations, or the like. In some embodiments, the communication generation system may update the user device with additional resources (e.g., memory resources, processing resources, networking resources, etc.) or to include applications required for performing certain tasks, such as specified applications or programs.

As shown in block 206, the process flow 200 of this embodiment includes receiving an event, wherein the event includes a task to be completed to resolve the event. In some embodiments, the task may include diagnostic testing, component replacement, securitization operations, configuration management, or the like. In this way, the task may include one or more steps or action items to be completed. For example, as shown in FIG. 3, the event 328 may be received by the artificial intelligence (AI) model 326. In some embodiments, the team 324 may determine the task 330 to resolve the event 328. In some embodiments, the user 316 or the designated user 332 may determine the task 330. In some embodiments, the AI model 326 may determine the task 330 to resolve the event 328. In some embodiments, the event may require multiple tasks to be completed to resolve the event, depending on the complexity of the event. In this way, the AI model may be able to break down the event into actionable tasks that may be performed by the team to resolve the event. In some embodiments, the AI model may understand the capabilities of the team and the associated users and create the tasks according to the team's (and users') abilities.

In some embodiments, the event may be a scheduled event or an unscheduled event. Scheduled events may include outcomes from meetings (e.g., meetings associated with the team), planned downtimes (e.g., system updates, patch management, etc.), maintenance, monitoring, audits, deployments, trainings, developments, response drills, and the like. Unscheduled events may include failures (e.g., hardware failures, software failures, network outages, or the like), security incidents, operational issues, environmental issues, incident responses, performance issues, regulatory and compliance issues, and the like.

Additionally, or alternatively, the event may be an interruption event and may require quick resolution to be resolved. In this way, the timeliness of the response to the event may be an important factor in ensuring the event does not disrupt other systems and/or components. The AI model may, when dealing with time-sensitive events, quickly disperse and assign tasks to designated users in order for the event to get resolved in a timely fashion.

As shown in block 208, the process flow 200 of this embodiment includes determining a designated user to complete the task, wherein the determination is based on the set of user personas, the set of device data, and the event. In some embodiments, the designated user includes one or more users of the team. In this way, the designated user may include multiple users that assist in resolving the event by completing tasks. For example, the tasks may be split up among the designated users selected to perform the tasks.

In some embodiments, the AI model may analyze the set of user personas to determine which user may be the most efficient at handling the task. In this way, the AI model may determine the users' dispositions, attributes, and questionnaires to determine the most appropriate user to be designated to complete the task. The AI model may also analyze collaboration tendencies among the users of the team. The AI model may, if multiple users are assigned to resolve an event, assign the users who typically work well with each other. To do this, the AI model may analyze historical outcomes of collaborations along with the set of user personas to determine which users should collaborate on a particular task and/or event.

The designated user may be assigned the task based on the AI model's determination of the task and the user's ability to complete the task (e.g., through analysis of the user persona). The AI model may determine that a user, based on the user's device data, is available and prepared to complete the task. For example, if an event is received and a user is typically available at the time of the received event, the AI model may select the user as the designated user. Further, the AI model's decision of the designated user may be based on the user's experience in dealing with similar tasks, the user's preference in dealing with similar tasks, the type of event, and the like. Further still, the AI model may base the decision on the capabilities of the user device (e.g., whether particular applications are installed), and when the user is typically available to complete tasks. For example, as shown in FIG. 3, the AI model 326 may choose a designated user 332 from the team 324 based on the user persona 302, the device data 308, and the event 328. In this way, the AI model 326 may understand the team's 324 capabilities and the requirements to resolve the event 328 to make a determination on which user should be the designated user 332.

In some embodiments, the designated user may be selected from a team (e.g., the team of users), a different team associated with the entity, a different team associated with a different entity, or the like. For example, the designated user may include employees, contractors, or individuals associated with the entity, which may include users on a different team. In this way, the designated user may have specific duties and/or actions relating to the task and event resolution. In another example, the designated user may include selecting from a third-party entity. For example, the designated user may include an individual contracted from a third-party entity to assist with event resolution procedures. In this way, the designated user may include an external subject matter expert, an uncommon and/or specialized individual, or the like.

In some embodiments, determining the designated user may include determining an initial designated user to complete at least a portion of the task. In some embodiments, an additional designated user to complete at least an additional portion of the task may be determined. The additional designated user may take over the task the initial designated user was performing or may start a new task. Further, in some embodiments, the additional designated user may simultaneously work on the task or be assigned an additional task after the initial designated user completes the task. For example, as shown in FIG. 3, the AI model 326 may select an additional designated user 334 along with the designated user 332 to complete the task 330.

Further, in some embodiments, the avatars resembling the initial designated user and the additional designated user may be used during a task or an event resolution. For example, the initial designated user may have added comments, explanations, notes, or the like to the task. The initial designated user's avatar may provide the additional designated user with an update on the status of the task during handover of the task. In some embodiments, the additional designated user may ask the avatar to summarize the actions the initial designated user took while working on the task. Further, in some embodiments, the additional designated user may ask the avatar specific questions related to the task and the initial designated user's work on the task. Additionally, or alternatively, the avatar's answers to the questions may provide background information relating to why the initial designated user took certain actions.

In some embodiments, the communication generation system (e.g., the system 130) may generate reports associated with the event. These reports may include a summary report, an action report, and an assignment report. The summary report may include information associated with the event, the designated user, the task, completion status of the task, and the like. The action report may include an additional required to resolve the event. The assignment report may include assigning the additional task to the designated user (or, in some embodiments, the additional designated user). For example, as shown in FIG. 3, the AI model 326 may generate reports (e.g., report generation 338) that includes the summary report 340, the action report 342, and the assignment report 344. Further, in some embodiments, these reports may be dispersed to the team, the designated user, and/or the additional designated user (if applicable).

In some embodiments, the reports generated (e.g., the summary report, the action report, and the assignment report) may be transformed into different modalities, depending on the preference of the user. For example, as shown in FIG. 3, the designated user 332 may select a modality (e.g., via modality selection 336) to transform the reports from the report generation 338 step to a modality of the designated user's 332 choice. In some embodiments, the modality selection may include a textual report, a video report, an auditory report, or the like. In some embodiments, the modality selection may be customizable for each user of the team (e.g., the modality of the report(s) for each user may be different). For example, one user may receive video reports while another may receive textual reports while yet another may receive audio reports. In this way, the reports may be delivered in a modality that is most preferred by each user of the team.

In some embodiments, the avatars associated with the users may deliver the reports. The avatars may deliver a video recording, audio recording, textual report, or the like to the users of the team. The user receiving the reports may select which avatar should deliver the report. Further, in some embodiments, the avatar(s) delivering the report may represent the users work worked on the task or event the report is related to. In this way, the report deliver may be customizable and provide personalized information of the reports being delivered. For example, the avatar 346 may deliver the summary report 340, action report 342, or assignment report 344.

In some embodiments, the communication system may include a platform environment. The platform environment may include an extended reality environment, virtual reality environment, augmented reality environment, parallel reality environment, or the like. The platform environment may include an interface for the team to develop an action plan to resolve an event. In this way, each user of the team may have access to the platform environment, via their respective user devices, to offer input relating to event resolution. Further, the platform environment may also be used for users to receive their task assignments. In some embodiments, designated users' task assignment may come from other users of the team or from the AI model. Additionally, or alternatively, while the team is developing the action plan, the AI model may synthesize team or user feedback and input within the platform environment. This synthesis of information may include determining which user should be the designated user, determining which tasks are appropriate to resolve the event, determining input to investigate event resolution techniques further, determining further input to maintain topics discussed by the users, and the like.

Further, in some embodiments, the AI model may determine that a user has become distracted within the platform environment. For example, a user may become distracted by turning the user's attention to a different unrelated task, another application, or the like. The AI model may prompt the distracted user via the user device. In this way, the AI model may alter settings of the distracted user's device, such as adjusting screen brightness, audio outputs, interface settings, sensory inputs, or the like.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for dynamically generating communication channels using advanced computational models for data analysis and automated processing, the system comprising:
a processing device;
a non-transitory storage device containing instructions when executed by the processing device, causes the processing device to perform the steps of:
receive a set of user personas, wherein the set of user personas is associated with each user of a team, and wherein the team comprises a plurality of users;
receive a set of device data, wherein the set of device data comprises user device information associated with a user device associated with each user of the team;
receive an event, wherein the event comprises a task to be completed to resolve the event; and
determine a designated user to complete the task, wherein the determination is based on the set of user personas, the set of device data, and the event.

2. The system of claim 1, wherein the set of user personas further comprises a user disposition, wherein the user disposition is associated with each user of the team, and wherein the disposition comprises:
a user attribute, wherein the user attribute comprises an ability of each user of the team to complete the task; and
a user questionnaire, wherein the user questionnaire comprises a task preference of each user of the team.

3. The system of claim 1, wherein the set of device data further comprises:
geolocation data, wherein the geolocation data comprises a physical location of the user device;
historical usage data, wherein the historical usage data comprises uptime of each user of the set of users; and
device performance, wherein the device performance comprises functionality data of each user device associated with each user of the team.

4. The system of claim 1, wherein the designated user comprises one or more users of the team.

5. The system of claim 4, wherein determining the designated user further comprises:
determining an initial designated user to complete at least a portion of the task, wherein the initial designated user is based on the set of user personas, the set of device data, and the event; and
determining an additional designated user to complete at least an additional portion of the task, wherein the additional designated user is based on the set of user personas, the set of device data, and the event.

6. The system of claim 1, wherein executing the instructions further causes the processing device to:
generate a summary report, wherein the summary report comprises information associated with the event, the designated user, the task, and completion status of the task;
generate an action report, wherein the action report comprises an additional task necessary to be completed to resolve the event;
generate an assignment report, wherein the assignment report comprises assigning the additional task to the designated user; and
transmit the summary report, the action report, and the assignment report to the designated user.

7. The system of claim 6, wherein the transmitting the summary report, the action report, and the assignment report to the designated user further comprises transforming the summary report, the action report, and the assignment report into a modality based on a user modality preference.

8. A computer program product for dynamically generating communication channels using advanced computational models for data analysis and automated processing, the computer program product comprising a non-transitory computer-readable medium comprising code causing an apparatus to:
receive a set of user personas, wherein the set of user personas is associated with each user of a team, and wherein the team comprises a plurality of users;
receive a set of device data, wherein the set of device data comprises user device information associated with a user device associated with each user of the team;
receive an event, wherein the event comprises a task to be completed to resolve the event; and
determine a designated user to complete the task, wherein the determination is based on the set of user personas, the set of device data, and the event.

9. The computer program product of claim 8, wherein the set of user personas further comprises a user disposition, wherein the user disposition is associated with each user of the team, and wherein the disposition comprises:
a user attribute, wherein the user attribute comprises an ability of each user of the team to complete the task; and
a user questionnaire, wherein the user questionnaire comprises a task preference of each user of the team.

10. The computer program product of claim 8, wherein the set of device data further comprises:
geolocation data, wherein the geolocation data comprises a physical location of the user device;
historical usage data, wherein the historical usage data comprises uptime of each user of the set of users; and
device performance, wherein the device performance comprises functionality data of each user device associated with each user of the team.

11. The computer program product of claim 8, wherein the designated user comprises one or more users of the team.

12. The computer program product of claim 11, wherein determining the designated user further comprises:
determining an initial designated user to complete at least a portion of the task, wherein the initial designated user is based on the set of user personas, the set of device data, and the event; and
determining an additional designated user to complete at least an additional portion of the task, wherein the additional designated user is based on the set of user personas, the set of device data, and the event.

13. The computer program product of claim 8, wherein the code further causes the apparatus to:
generate a summary report, wherein the summary report comprises information associated with the event, the designated user, the task, and completion status of the task;
generate an action report, wherein the action report comprises an additional task necessary to be completed to resolve the event;
generate an assignment report, wherein the assignment report comprises assigning the additional task to the designated user; and
transmit the summary report, the action report, and the assignment report to the designated user.

14. The computer program product of claim 13, wherein the transmitting the summary report, the action report, and the assignment report to the designated user further comprises transforming the summary report, the action report, and the assignment report into a modality based on a user modality preference.

15. A method for dynamically generating communication channels using advanced computational models for data analysis and automated processing, the method comprising:
receiving a set of user personas, wherein the set of user personas is associated with each user of a team, and wherein the team comprises a plurality of users;
receiving a set of device data, wherein the set of device data comprises user device information associated with a user device associated with each user of the team;
receiving an event, wherein the event comprises a task to be completed to resolve the event; and
determining a designated user to complete the task, wherein the determination is based on the set of user personas, the set of device data, and the event.

16. The method of claim 15, wherein the set of user personas further comprises a user disposition, wherein the user disposition is associated with each user of the team, and wherein the disposition comprises:
a user attribute, wherein the user attribute comprises an ability of each user of the team to complete the task; and
a user questionnaire, wherein the user questionnaire comprises a task preference of each user of the team.

17. The method of claim 15, wherein the set of device data further comprises:
geolocation data, wherein the geolocation data comprises a physical location of the user device;
historical usage data, wherein the historical usage data comprises uptime of each user of the set of users; and
device performance, wherein the device performance comprises functionality data of each user device associated with each user of the team.

18. The method of claim 15, wherein the designated user comprises one or more users of the team.

19. The method of claim 18, wherein determining the designated user further comprises:
determining an initial designated user to complete at least a portion of the task, wherein the initial designated user is based on the set of user personas, the set of device data, and the event; and
determining an additional designated user to complete at least an additional portion of the task, wherein the additional designated user is based on the set of user personas, the set of device data, and the event.

20. The method of claim 15, wherein the method further comprises:
generating a summary report, wherein the summary report comprises information associated with the event, the designated user, the task, and completion status of the task;
generating an action report, wherein the action report comprises an additional task necessary to be completed to resolve the event;
generating an assignment report, wherein the assignment report comprises assigning the additional task to the designated user, and
transmitting the summary report, the action report, and the assignment report to the designated user.
